(19) United States
(12) Patent Application Publication
(10) Pub. No.: US 2009/0163260 A1
(43) Pub. Date: Jun. 25, 2009

(54) Combine harvester having blower for pneumatic cleaning

(76) Inventor: Ulrich Claes, Dissen (DE)

Correspondence Address: CHRISTINE JOHNSON ESQ., 151 Trenton Rd., Fairless Hills, PA, 19030, US

(21) Appl. No.: 12/334,593

(22) Filed: Dec. 15, 2008

(30) Foreign Application Priority Data
Dec. 20, 2007 (DE) 10 2007 062 531.6

(51) Int. Cl. A01F 12/44; A01F 12/48

(52) U.S. Cl. 460/100

(57) ABSTRACT

A combine harvester has a blower for pneumatic cleaning which comprises an impeller (22) able to rotate in a blower casing (23) and an air duct (25) leading out of the blower casing (23). The air duct (25) is bounded by a wall (28) having an inside surface of convex curvature.

### CROSS REFERENCE TO RELATED APPLICATIONS

This application claims priority under 35 USC 119(a) to earlier filed German application 10 2007 062 531.6 filed on Dec. 20, 2007 in the German patent office and incorporated herein by reference in its entirety.

### FIELD OF THE INVENTION

The present invention relates combine harvesters, and more particularly to combine harvesters having a blower for pneumatic cleaning.

### BACKGROUND OF THE INVENTION

Blowers for pneumatic cleaning for combine harvesters generally comprise one or more centrifugal blowers which are arranged on a common shaft and which have impellers rotating in a blower casing which draw in air in a direction parallel to their axis and expel it into an air duct aligned tangentially to the movement of the impeller vanes. One problem with this known arrangement is that in order to produce a relatively high velocity flow of air, the blower has to be of a considerable capacity.

There exists a need for combine harvesters having a blower for pneumatic cleaning in which a more beneficial incident flow onto the sieves can be obtained.

### SUMMARY OF THE INVENTION

Embodiments of the present invention provide combine harvesters having a blower for pneumatic cleaning that achieves a beneficial incident flow onto the sieves. In one embodiment of the invention a blower for a combine harvester comprises at least one impeller able to rotate in a blower casing, and an air duct leading out of the blower casing. The air duct is bounded by a wall having an inside surface of convex curvature.

### BRIEF DESCRIPTION OF THE DRAWINGS

FIG. 1 is a schematic section through a combine harvester according to the present invention.

FIG. 2 shows an enlarged detail of the combine harvester shown in FIG. 1.

FIG. 3 is an axial section through the blower of the combine harvester.

### DETAILED DESCRIPTION OF THE INVENTION

Blowers for pneumatic cleaning for combine harvesters, of the kind described in EP 1 407 656 A1 for example, generally comprise one or more centrifugal blowers which are arranged on a common shaft and which have impellers rotating in a blower casing which draw in air in a direction parallel to their axis and expel it into an air duct aligned tangentially to the movement of the impeller vanes.

The arrangement of a blower for pneumatic cleaning of this kind in a combine harvester is described in DE 10 2005 027 726 A1. The air duct blows air obliquely from below against sieves through which cereal grains which are directed onto the sieves are able to pass, while lighter constituents of the harvested crop, which are guided onto the sieves together with the grains, are carried away by the flow of air from the blower for pneumatic cleaning and are fed to tailings or are ejected from the combine harvester.

A problem with this arrangement is that the flow of air passes through the sieves principally in their front region which is adjacent to the blower. In this way, the flow of air to some degree forms, in the front region of the sieves, a cushion of air which supports non-grain constituents, which means that even a low velocity of flow is enough to carry such non-grain constituents away towards tailings or towards an ejection opening at the rear end of the sieves. In a rear region of the sieves on the other hand the cushion of air is weaker or is entirely absent, which means that at that point a high velocity of flow is required in order to feed the non-grain constituents onwards effectively. To produce this high velocity of flow, the blower has to be of a considerable capacity.

DE 29 22 607 A1 describes a blower for pneumatic cleaning for a combine harvester in which adjustable baffles in the air duct allow the direction of a flow of air which is steered towards the sieves to be controlled. As long as these baffles are parallel to the upper side or lower side of the air duct, they do not affect the direction of the flow of air and flow takes place through the sieves predominantly in the front region thereof.

By adjusting the baffles it is possible for the flow of air to be guided towards the sieves at a small angle but at the same time this also results in a weakening of a flow of air which travels above the sieves. There is also a risk that pieces of material such as, say, straw and husks which are carried along in the flow of air will become caught at the baffles and, over the course of time, will plug the air duct.

The present invention provides a combine harvester having a blower for pneumatic cleaning in which a more beneficial incident flow onto the sieves can be obtained without any major changes to the geometry or positioning of the blower, thus enabling a good separating efficiency to be maintained over the entire length of the sieves. Furthermore, some embodiments of the invention provide a combine harvester which achieves a good separating performance in an efficient manner, for example without making excessive demands on the capacity of the blower.

One embodiment of the invention provides a combine harvester having a blower for pneumatic cleaning which comprises vanes able to rotate in a blower casing and an air duct leading out of the blower casing, and in which the air duct is bounded by a wall having an inside surface of convex curvature. When the flow of air driven by the vanes sweeps over the inside surface of convex curvature, then the flow of air follows the contour of the inside surface due to the Coanda effect, and what is obtained at the end of the air duct is thus a flow of air which propagates along a tangential extension of the inside surface.

One embodiment of the invention brings about this effect in an efficient manner by orienting at least a part of the wall, which part is close to the casing in one embodiment of the invention, to face an air inlet opening into the air duct such that the flow of air from the blower is incident on this part of the wall. In that manner the said part of the wall steers the flow of air away while at the same time creating back pressure, so that an accelerated flow of air is obtained in a region of the cross-section of the duct which is adjacent the wall.

To deflect this accelerated flow of air effectively in a direction which cannot be achieved with a straight air duct, at least a part of the wall which is distant from the casing preferably faces away from the air inlet opening into the air duct.

With the help of the convex wall, a redirection of the flow of air is achieved without air baffles being required for this purpose along the duct. To reduce a possibility of pieces of material which are carried along in the flow becoming caught in the air duct, the latter can therefore usefully be kept substantially free of air-directing members around which air is able to flow on two sides.

On its side opposite to the wall having an inside surface of convex curvature, the air duct may be bounded by a wall having an inside surface of concave curvature, which means that there is no substantial change in the cross-section of the air duct over the length thereof and the air duct can carry laminar flow without loss of velocity.

The wall opposite to the wall having an inside surface of convex curvature may also be of a straight form; this is simpler to produce.

In the combine harvester according to the invention, the inside surface of convex curvature preferably forms a bottom side of the air duct.

The air duct preferably opens into a sieve enclosure of the combine harvester, in which case an edge facing towards the air duct of at least one sieve arranged in the sieve enclosure divides a flow of air travelling through the air duct into a flow which passes above the edge and a flow which passes below the edge. The flow which passes below the edge, which is intended to pass through the sieve downstream of the edge thereof and to generate a cushion of air thereon, is preferably stronger in this case than the flow which passes above the edge, which flow is used to carry away particles which are raised up by the cushion of air.

To enable a high proportion of the flow of air to be steered below the sieve, a part of the wall which is distant from the casing is preferably situated below a plane defined by the sieve and, in the direction away from the casing of the blower, a tangent to the part distant from the casing, and the plane, diverge from one another.

In the direction leading away from the blower, a floor of the sieve enclosure and the sieve preferably taper towards one another in order to guide the flow of air which passes below the edge of the sieve through the sieve in such a way that it is distributed over the entire area of the sieve.

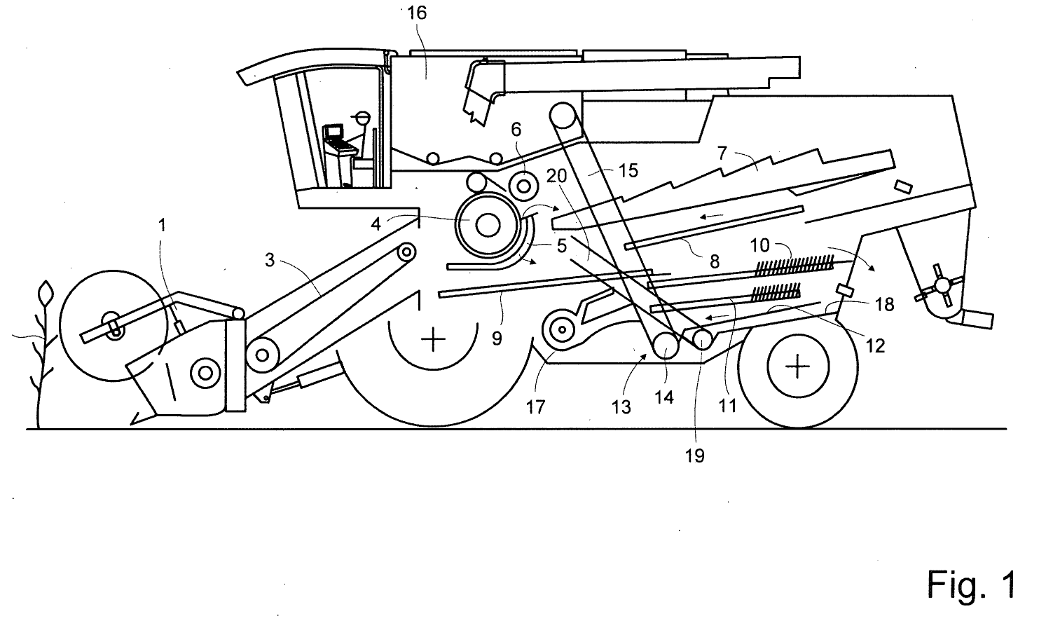

At its front end, the embodiment of a combine harvester of the invention which is shown schematically in FIG. 1 carries an interchangeable cutter bar such as, say, a cereal cutter bar 1 for cutting and gathering crop 2 for harvesting. An inclined conveyor 3 feeds the cut crop to a threshing drum 4 whose axis is aligned transversely to the direction of travel of the combine harvester and to a threshing concave 5. The grain which is threshed out of the harvested crop passes through the threshing concave 5. A stripper drum 6 is used to feed the threshed harvested crop on to a separating means 7, which is shown in the form of a straw shaker in the present case, which separates the remaining grain and any small pieces of non-grain material out of the flow of threshed harvested crop. What may also be provided as a separating means 7 in place of the straw shaker is an axial separator, having for example one or two drums which extend in the longitudinal direction of the combine harvester, surrounded by separating concaves.

Harvested crop which has fallen through grids belonging to the separating means 7 makes its way onto a chaffer board 8 which extends below the separating means 7 and which slopes down in the forward direction, and via this latter to a preparing board 9 on which it is brought together with grain which was separated out directly at the threshing drum 4 and which passed through the threshing concave 5. The flow of material obtained in this way, which is rich in grain but also contains finely comminuted non-grain constituents, is fed onwards to a top sieve 10.

The top sieve 10, and a bottom sieve 11 which is approximately parallel to the top sieve 10 and is situated below it, are enclosed at the bottom and sides by a sieve enclosure. The floor 12 of the sieve enclosure, which floor 12 is shown in FIG. 1, slopes down in the forward direction from an edge adjacent the rear edge of the bottom sieve 11 to an auger trough 13 in which an auger conveyor 14 rotates. The auger conveyor 14 and a grain elevator 15 which is connected thereto feed the grain which has been cleaned of non-grain constituents and which collects on the floor 12 into a grain tank 16 behind the driver's cab of the combine harvester.

Arranged in front of the sieves 10, 11 is a centrifugal blower 17 to supply a flow of air, part of which flow of air sweeps through the sieves 10, 11 and part of which flow of air sweeps across them in order to raise up lightweight constituents of the harvested crop situated on the sieves 10, 11 and to carry them away. Constituents which are carried past a rear edge of the top sieve 10 by the flow of air are ejected directly from the combine harvester, as indicated by an arrow in FIG. 1. Constituents which have made their way through the top sieve 10 and onto the bottom sieve 11 and which are carried away from there by the flow of air are often fragments of ears which have not been fully threshed. These travel beyond the rear edge of the bottom sieve 11 and drop onto a tailings board 18, collect at the bottom edge of the latter at a second auger 19, and make their way via this latter and an elevator 20 back to the threshing drum 4.

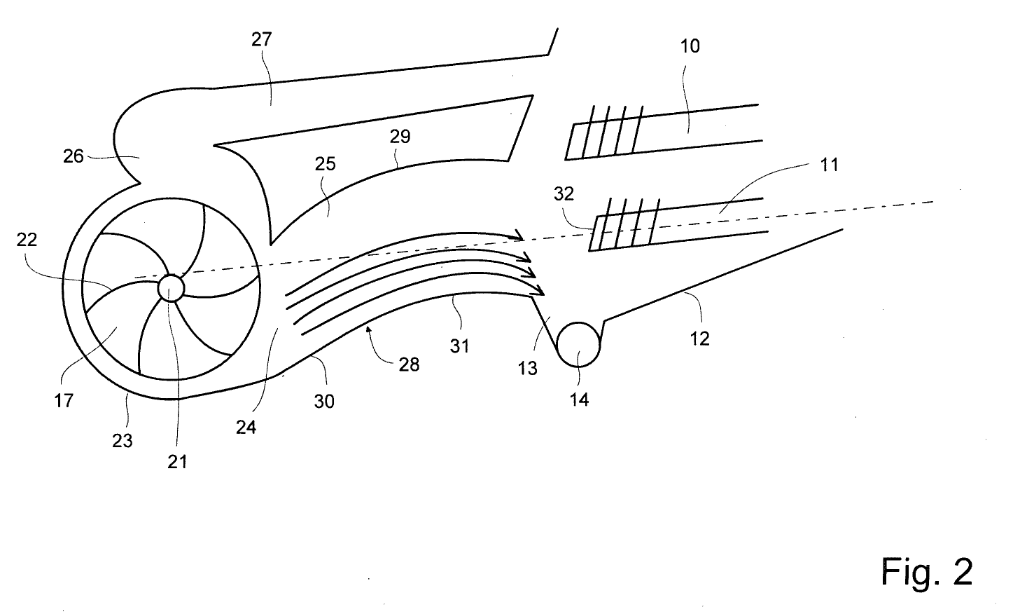

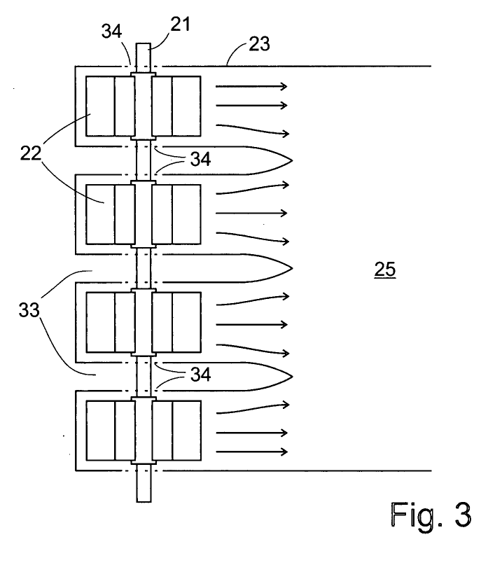

FIG. 2 is a detail view showing the sieves 10, 11 and the blower 17 which is associated therewith. On a shaft 21 of the blower 17 which is oriented transversely to the plane of the drawing can be seen an impeller 22 which is surrounded by a casing 23. As is shown in FIG. 3 in an axial section through the blower 17, a plurality of impellers 33 may be arranged on the shaft 21, spread out axially, the rotation of which draws in fresh air in the axial direction from the outside of the combine harvester or from the gaps between the impellers 22 and through inlet openings 34 in the blower casing 23 and produces a flow of air which is of uniform strength across the width of the combine harvester.

In the embodiment which is shown here, the blower casing 23 has two openings in its outer circumference, these being an inlet opening 24, which is oriented substantially in the opposite direction from the direction of travel of the combine harvester, into a main air duct 25 and, approximately at the crest of the blower casing 23, an inlet opening 26 into an ancillary air duct 27. The main air duct 25 has a lower wall having an upper side of convex curvature. An upper wall 29 of the main air duct 25 may, as shown in FIG. 2, be of a concave curvature complementary to the lower wall 28 or may be straight. A region 30 of the lower wall 38, which region 30 is adjacent the impeller 22, faces towards the impeller 22, thus causing the flow of air which is driven into the duct 25 by the impeller 22 to be deflected upwards by the region of wall 30 at least in a lower region of the cross-section of the duct. The accelerated flow of air which is obtained by this means close to the lower wall 28 follows the path of the lower wall 28 even along a downstream region 31 of the wall 28 which faces away from the impeller 22. In this region 31, the wall 28, looking in the direction of flow, draws away from a plane which is defined by the substantially planar bottom sieve 11 and which is shown in FIG. 2 as a dotted and dashed line. In this way, there is obtained, at an outlet opening from the duct 25 at which this latter merges with the sieve enclosure, a flow of air which on average is directed slightly downwards and of which by far the predominant part sweeps below a front edge 32, on which the flow is incident, of the bottom sieve 11. The auger trough 13 having the auger conveyor 14 rotating therein affects the air flow to only an insignificant degree in operation because it is generally full of grain.

In this way, the curvature of the wall 28 makes it possible for a major proportion of the flow of air flowing through the main air duct 25 to be directed below the bottom sieve 11 without the main air duct itself having to be situated, for this reason, at such a low level that there is a risk of grain penetrating into the main air duct 25. This risk is further reduced by the path of the downstream region 31 of the wall 28, which slopes down in the rearward direction.

Because the distance between the bottom sieve 11 and the floor 12 becomes increasing small towards the rear of the combine harvester, that proportion of the flow of air through the main air duct which has passed below the front edge 32 is successively forced through the bottom sieve 11. The air which passes through, which is evenly distributed over the entire area of the bottom sieve 11, keeps the grain in motion on the bottom sieve 11, which means that the grain is sieved efficiently and quickly, and it holds lightweight constituents suspended, which means that these can be fed efficiently to the tailings even by a weak flow of air which sweeps along above the bottom sieve 11.

Because of the parallel arrangement of the top and bottom sieves 10, 11, the flow of air through the top sieve 10 is also distributed over a large area.

In the embodiment shown in FIG. 2, a flow of air from the ancillary air duct 27 sweeps over the top sieve 10 and carries along with it to an ejection opening at the rear particles which are caused to float by the air which passes through the sieve. Alternatively, by making the sieve enclosure of a suitable shape, it would also be possible to compel the air ascending through the top sieve 10 to be deflected backwards above the said top sieve 10 in order in this way to carry away the floating particles.

What is claimed is:

1. A combine harvester having a blower for pneumatic cleaning which comprises at least one impeller (22) able to rotate in a blower casing (23) and an air duct (25) leading out of the blower casing (23), characterised in that the air duct (25) is bounded by a wall (28) having an inside surface of convex curvature.

2. A combine harvester having a blower for pneumatic cleaning according to claim 1, characterised in that at least a part (30) of the wall (28), which part (30) is close to the casing, is oriented to face an air inlet opening (24) into the air duct (25).

3. A combine harvester having a blower for pneumatic cleaning according to claim 1, characterised in that at least a part (31) of the wall (28) which is distant from the casing is oriented to face away from an air inlet opening (24) into the air duct (25).

4. A combine harvester having a blower for pneumatic cleaning according to one claim 1, characterised in that the air duct (25) is free of air-directing members around which air is able to flow on two sides.

5. A combine harvester having a blower for pneumatic cleaning according to claim 1, characterised in that, on its opposite side from the wall (28) having an inside surface of convex curvature, the air duct (25) is bounded by a wall (29) having an inside surface of concave curvature.

6. A combine harvester having a blower for pneumatic cleaning according to claim 1, characterised in that, on its opposite side from the wall (28) having an inside surface of convex curvature, the air duct (25) is bounded by a straight wall.

7. A combine harvester having a blower (17) for pneumatic cleaning according to claim 1, characterised in that the wall (28) of convex curvature forms a bottom side of the air duct (25).

8. A combine harvester according to claim 7, characterised in that the air duct (25) opens into a sieve enclosure, and in that an edge (32) facing towards the air duct (25) of at least one sieve (11) arranged in the sieve enclosure divides a flow of air travelling through the air duct (25) into a flow which passes above the edge (32) and a flow which passes below the edge.

9. A combine harvester according to claim 8, characterised in that the flow which passes below the edge (32) is stronger than the flow which passes above the edge.

10. A combine harvester according to claim 6, characterised in that a part (31) of the wall (28) which is distant from the casing is situated below a plane defined by the sieve (11) and in that, in the direction away from the casing (17) of the blower, a tangent to the part (31) distant from the casing, and the plane, diverge from one another.

11. A combine harvester according to claim 8, characterised in that, in the direction leading away from the blower (17), a floor (12) of the sieve enclosure and the sieve (11) taper towards on one another.
